(19) United States
(12) Patent Application Publication
(10) Pub. No.: US 2010/0328088 A1
(43) Pub. Date: Dec. 30, 2010

(54) Mood-Interacting Shoe Device

(76) Inventors: Chyi-Cheng Lin, Taipei-City (TW); Yun-Yu Wang, Colorado Springs, CO (US)

Correspondence Address: HDLS IPR Services, PO Box 220746, Chantilly, VA, 20153, US

(21) Appl. No.: 12/491,283

(22) Filed: Jun. 25, 2009

(51) Int. Cl. G08B 21/00; G06F 17/00

(52) U.S. Cl. 340/666; 700/94

(57) ABSTRACT

A mood-interacting shoe device includes a shoe body and an interactive sensing mechanism. The interactive sensing mechanism further includes a heart rate sensor, a speed sensor, a pressure sensor, a microprocessor and a radio frequency emitter. The heart rate sensor senses the heart rate value, the speed sensor senses the marching rate, and the pressure sensor senses the pressure distribution value when the thenar exerts pressure. The sensed values will be transmitted to the microprocessor, where the sensed values are analyzed and thereby the mood of the user is determined accordingly. The analysis result is transmitted to the video and music player through the radio frequency emitter, such that the video and music player can play music corresponding to the mood; and a LED display unit is further provided such that the user can understand whether each sensor operates normally or not.

### BACKGROUND OF THE INVENTION

1. Field of the invention

The invention relates to a mood-interacting shoe device which can sense and calculate data collected through sensors and microprocessors therein so as to determine the mood of the user, and change the music played by a video and music player in accordance with various moods, thereby accomplish a mood-interacting function.

2. Description of the prior art

There are many kinds of shoes on present market. In addition to protect feet, shoes can make walking more convenient. For responding to the requirement, a great variety of shoe styles, as well as shoes with various functional types are developed. Other than increasing beautiful appearance, better effects can be achieved on sport, and therefore, a great variety of shoes have been mass produced.

Nevertheless, most of conventional shoes have been designed based on different styles or different exercising requirement, and accordingly, several points need to be improved as described below:

1. Traditionally, shoes are simply worn on feet; no means could be used to produce other interaction to the user during walking.

2. Lacking the interaction, the user will reduce the enjoyment of wearing shoes.

Thus it can be seen that the above-described conventional techniques have many disadvantages and deficiencies, which are not perfect in design and need to be improved urgently.

In view of those disadvantages and deficiencies derived from the above-described conventional techniques, the inventor had devoted to improve and innovate earnestly, and after studying intensively and diligently for many years, had developed successfully the mood-interacting shoe device according to the invention.

### SUMMARY OF THE INVENTION

The object of the invention is to provide a mood-interacting shoe device, characterized in that the device can sense the heart rate, the moving speed, and the pressure distribution value when the thenar exerts the pressure, determine the mood of the user by means of calculation and analysis, and then play corresponding music in accordance with the current mood, thereby achieve an effect of producing interacting feeling through shoes during walking or running.

The mood-interacting shoe device that can achieve the above-mentioned object of the invention comprises mainly: a shoe body and an interactive sensing mechanism, wherein said interactive sensing mechanism is provided within the shoe body, and the interactive sensing mechanism comprises a heart rate sensor, speed sensor, pressure sensor, microprocessor and a radio frequency emitter, wherein the heart rate sensor is provided at the side of the shoe body, and senses heart rate value through a foot; the speed sensor is provided within the shoe body to sense the moving speed; and the pressure sensor is provided within the sole of the shoe body to sense the pressure distribution value when the thenar exerts pressure; and the heart rate, moving rate and the pressure value as pressing thus-sensed will be transmitted to the microprocessor, where values thus-sensed will be computed and analyzed to determine the mood of the user; the analytical result will be transmitted to a video and music player via the radio frequency emitter, such that the video and music player can play different music in accordance with the mood, or play music each with different music speed or sound field; and a light emitting diode (LED) display unit is further provided such that the user can understand whether each sensor operates normally or not.

These features and advantages of the present invention will be fully understood and appreciated from the following detailed description of the accompanying Drawings.

### BRIEF DESCRIPTION OF THE DRAWINGS

FIGS. 1A, B, C, and D are structural views of the inventive mood-interacting shoe device;

FIG. 2 is a structural view showing the interactive sensing mechanism in the inventive mood-interacting shoe device; and

FIG. 3 is a mood distribution schematic view of the inventive mood-interacting shoe device.

### DETAILED DESCRIPTION OF THE PREFERRED EMBODIMENT

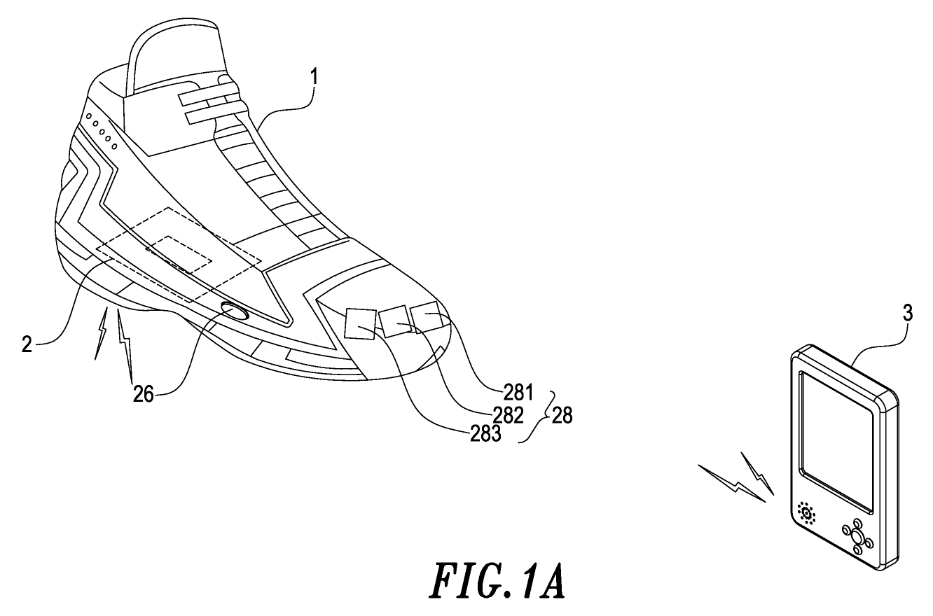

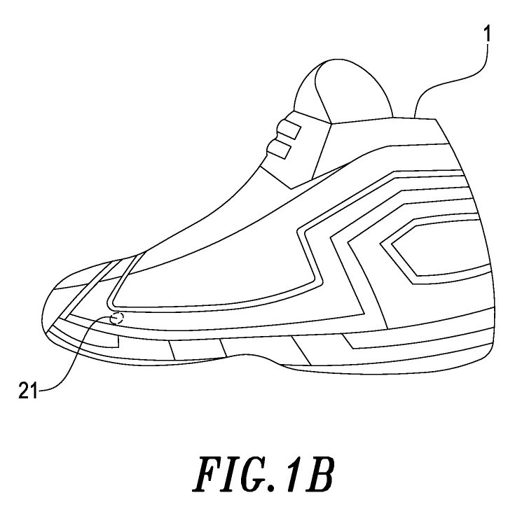

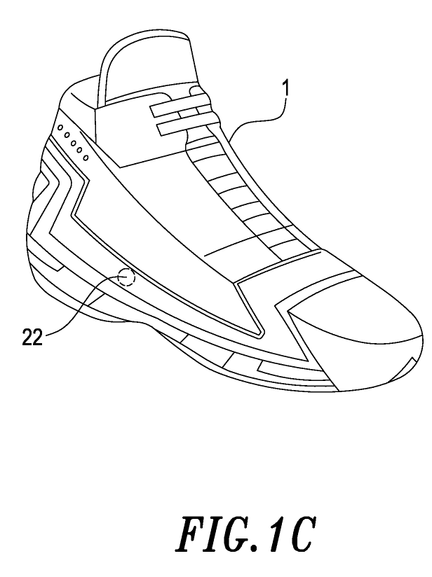

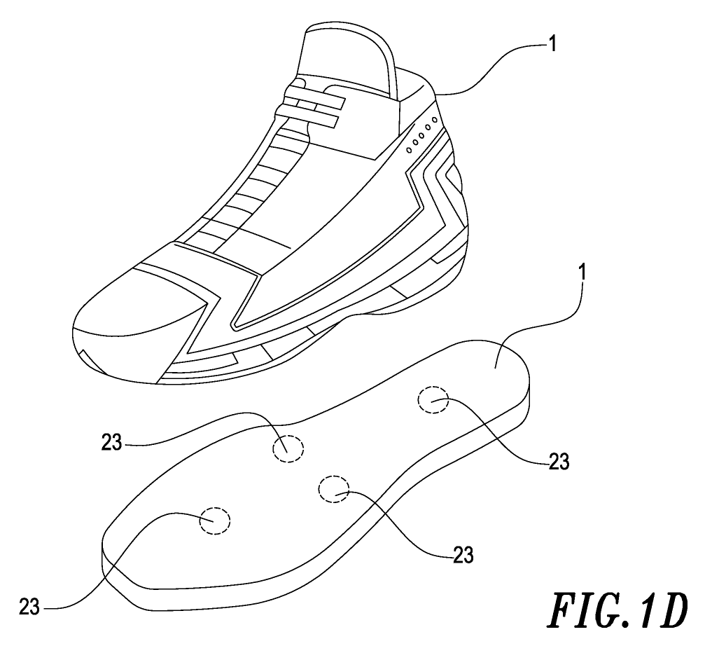

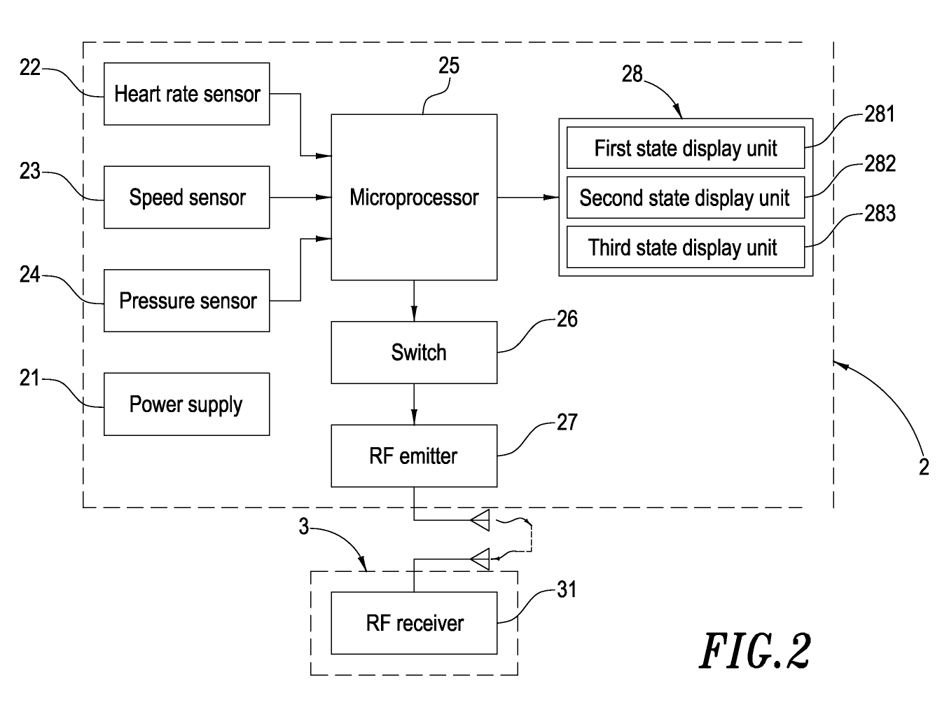

Referring to FIGS. 1A, B, C, and D, and FIG. 2, those structural views show that the inventive mood-interacting shoe device comprises mainly:

a shoe body 1, for being worn on a foot of a user;

an interactive sensing mechanism 2, provided within the shoe body 1, wherein the interactive sensing mechanism 2 comprises further a power supply 21, a heart rate sensor 22, a speed sensor 23, a pressure sensor 24, a microprocessor 25, a radio frequency emitter 27 and a LED display unit 28, wherein the power supply 21 supplies total electric power to the whole interactive sensing mechanism 2; wherein the heart rate sensor 22 is provided on a side of the shoe body, and is used to sense heart rate value through the foot, and then transmits the heart rate value thus-sensed to the microprocessor 25 (as shown in FIG. 1B); the speed sensor 23 is provided within the shoe body 1, and is used to sense the marching rate, and then transmits the moving rate thus-sensed to the microprocessor 25 (as shown in FIG. 1C); the pressure sensor 24 is provided within the sole, and is used to sense the pressure distribution value as pressing, and then transmits the pressure distribution value to the microprocessor 25 (as shown in FIG. 1D); the microprocessor 25 is used to receive the thus-sensed heart rate, moving rate and pressure value as pressing, calculate and analyze those sensed values to deduce the mood of the user, and the analytical result can be transmitted through a radio frequency emitter 27, and the transmitting action can be controlled by a switch 26; the radio frequency emitter 27 transmits a signal obtained from the calculation and analysis in the microprocessor 25 to a video and music player 3; the LED display 28 is linked to the microprocessor 25 and is provided outside of the shoe body 1, and comprises a first state display unit 281, a second state display unit 282 and a third state display unit 283, which can display current states of the heart rate sensor 22, the speed sensor 23 and the pressure sensor 24, and determine, through each display unit, whether each of sensors 281, 282, and 283 in the interactive sensing mechanism 2 operates normally, malfunctions or electric power exhausts;

a video and music player 3, comprising a radio frequency receiver 31, wherein the radio frequency receiver 31 receives the calculated and analyzed message transmitted by the radio frequency emitter 27 in the interactive sensing mechanism 2, and plays various music in accordance with the deduced mood, or music with different music speed or sound field, and the video and music player 3 may be a MP3, MP4, PDA or mobile communication set, the video and music player 3 may be a watch provided with a radio frequency receiver 31 and a state displaying panel, thereby can understand current heart rate, speed, and pressure distribution through the displaying panel.

Further, the heart rate sensor 22 measures heart rate through contacting at the position of a foot thumb. The speed sensor 23 is used to sense marching rate when the user moves, such as slow walking, jogging, or running. The pressure sensor 24 is provided and distributed over four different positions, and is used to calculate the average pressure distribution value of the gravity center.

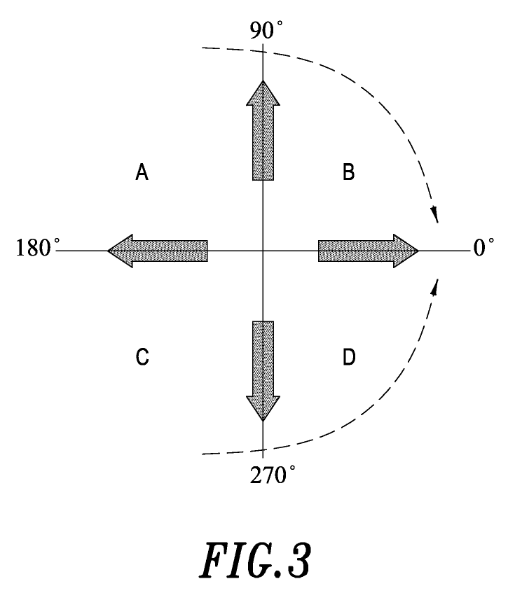

Referring to FIG. 3, a schematic view shows the mood distribution of the inventive mood-interacting shoe device. A range of accepting values is obtained experimentally and is used for the determination of mood. Critical values for these accepting values and speed are set. Then, values sensed by the heart rate sensor 22 and the speed sensor 23 are determined if they exceed those accepting range. As a rule, if the heart rate is determined to be faster and the speed is slower, the mood belongs to type A and is more exciting and negative; if the heart rate is determined to be faster and the speed is faster, the mood belongs to type B and is more exciting and positive; if the heart rate is determined to be slower and the speed is slower, the mood belongs to type C and is lower and negative; and if the heart rate is determined to be slower and the speed is faster, the mood belongs to type D and is lower and positive.

Mood of type A includes frightened, nervous, anger, afraid, annoyed, worried, and frustration.

Mood of B type includes excitement, astonishment, agitating, delight, and happy.

Mood of type C includes pain, sorrow, melancholy, depression, sick, tired, and weary.

Mood of type D includes happy, merry, tranquil, satisfactory, relief, satisfaction, relax, calmness and sleepiness.

Furthermore, moods included change by curve way within each type, for example, mood of type B changes gradually from more exciting mood of excitement and astonishment, to the less exciting mood of delight and happy; mood of type D changes from low mood of sleepiness and calmness to less exciting mood of happy and merry.

Further, the way to determine the speed comprises determining once whether the action is always kept within the accepting range per 10 speeds, since this depends on the continuity and stability of actions performed within a continuous time period. Accordingly, critical values are used to confirm the stability of actions, and states accumulated in a time period are used to determine the continuity and stability of actions.

The way for determining heart rate under keeping ideal heart rate can be carried out as followed:

220−age=the highest heart rate;

The highest heart rate×0.6=the lower limit of the ideal heart rate;

The highest heart rate×0.8=the upper limit of the ideal heart rate.

The way for determining pressure comprises of calculating the average pressure distribution value of the gravity center, and determines whether it belongs to good, normal, or poor depending on which region the gravity center falls in.

The mood-interacting shoe device provided according to the invention has following advantages over other conventional techniques:
1. When walking, the inventive mood-interacting shoe device can provide different interaction with the user by playing corresponding music, or changing music speed or sound field, with a video and music player in accordance with the actions and mood of the user.
2. By means of sensing, the present mood of the user can be determined by the inventive mood-interacting shoe device, and the user can enjoy an interactive amusement through the interaction with the device.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A mood-interacting shoe device, comprising:
a shoe body, useful for worn on a foot of a user;
an interactive sensing mechanism, provided within said shoe body, wherein said interactive sensing mechanism comprises a heart rate sensor, a speed sensor, a pressure sensor, a microprocessor and a radio frequency emitter, wherein said heart rate sensor is provided within said shoe body, and is used to sense the heart rate value, and then transmits the heart rate value thus-sensed to the microprocessor; said speed sensor is provided within said shoe body, and is used to sense a moving rate, and transmits the moving rate thus-sensed to the microprocessor; said pressure sensor is provided within a sole of said shoe body, and is used to sense the pressure distribution value as pressing, and transmits the pressure distribution value to the microprocessor; said microprocessor is used to receive the thus-sensed heart rate, moving rate and pressure value as pressing, calculate and analyze those sensed value to deduce the mood of the user, and then transmits the analytical result through the radio frequency emitter; and said radio frequency emitter is used to transmit the calculated and analyzed signal from said microprocessor to the video and music player;
a video and music player, comprising a radio frequency receiver, wherein said radio frequency receiver receives the calculated and analyzed message through the radio frequency emitter in the interactive sensing mechanism, and plays different corresponding music in accordance with various mood.

2. A mood-interacting shoe device as recited in claim 1, wherein a LED display is provided further outside of said shoe body, is linked with the microprocessor of said interactive sensing mechanism, and provides the user with the understanding whether each sensor operates normally through the LED display.

3. A mood-interacting shoe device as recited in claim 2, wherein said LED display comprises a first state display unit, a second state display unit, and a third state display unit that displays current state of the heart rate sensor, the speed sensor and the pressure sensor, respectively, so as to understand whether each sensor of the interactive sensing mechanism operates normally, malfunctions, or electric power exhausted through each display unit.

4. A mood-interacting shoe device as recited in claim 1, wherein said interactive sensing mechanism comprises further a power supply to provide the whole interactive sensing mechanism the electric power needed therefor.

5. A mood-interacting shoe device as recited in claim 1, wherein said interactive sensing mechanism comprises further a switch to control the signal transmission performed by the radio frequency emitter.

6. A mood-interacting shoe device as recited in claim 1, wherein said video and music player is one selected from the group consisting of MP3, MP4, PDA or a mobile communication device.

7. A mood-interacting shoe device as recited in claim 1, wherein said video and music player is a watch provided with a radio frequency receiver and a state display panel.

8. A mood-interacting shoe device as recited in claim 1, wherein the music played by said video and music player is music with different music speed or sound field.
